(19) United States
(12) Patent Application Publication
(10) Pub. No.: US 2016/0183674 A1
(43) Pub. Date: Jun. 30, 2016

(54) Table Tennis Table with a Honeycomb Core and a Method for its Manufacture

(71) Applicant: Richard lee, Rockville, MD (US)

(72) Inventor: Richard lee, Rockville, MD (US)

(21) Appl. No.: 14/826,406

(22) Filed: Aug. 14, 2015

Related U.S. Application Data
(60) Provisional application No. 62/037,192, filed on Aug. 14, 2014.

(51) Int. Cl. A47B 13/08; F16B 5/01; A63B 67/04; A47B 37/00

(52) U.S. Cl. CPC A47B 13/08; A47B 37/00; F16B 5/01; A63B 67/04

(57) ABSTRACT

A table tennis table that utilizes a honeycomb core for its structure and stability. The honeycomb core has top tabs and bottom tabs which fold at approximately a right angle to each tabs' respective original plane. The bent tabs provide more surface area (and hence more contact) between an upper surface on top of the honeycomb core and a bottom surface on a bottom of the honeycomb core. A method of manufacturing the table utilizes a tab bending guide in order to efficiently bend each tab. The table (without its upper and lower surface) is pushed through the tab bending guide which bends the tabs accordingly, upon which the upper and lower surfaces can then be fixed using glue to the honeycomb core.

### CROSS REFERENCE TO RELATED APPLICATIONS

This application claims benefit of U.S. provisional application 62/037,192, filed on Aug. 14, 2014, which is incorporated by reference herein in its entirety for all purposes.

### FIELD OF THE INVENTION

The present method relates to manufacturing a lightweight table tennis table that utilizes a honeycomb core for its structure and stability.

### BACKGROUND

Table tennis (also known as ping pong) has been enjoyed by the world since the 1880's, eventually becoming an Olympic sport in 1988. The International Table Tennis Federation (ITTF), the organization which regulates the standards and rules of table tennis, requires that an ITTF-certified table tennis table be 2.74 meters (nine feet) long, 1.52 meters (five feet) wide, 0.76 meters (two and a half feet) tall, and created with a surface material such that the table yields a uniform bounce of 9.1 inches when a standard ball is dropped from 11.8 inches above the surface. While recreational tables need not conform to such precise standards, table tennis enthusiasts still seek an experience that equals the professional.

Table tennis tables can be created using a variety of materials, including wood, plastic, and even concrete in the case of outdoor tables. However, the use of such materials leads to the creation of a table that is extremely heavy, difficult to transport, without the proper characteristics, and easily damaged by the elements. Recently, table tennis tables have been constructed using a combination of composite materials, but the same problems of weight and transportability have arisen.

What is needed is a method of manufacturing a table tennis table that conforms to the ITTF guidelines, while being lightweight and easily transportable.

### SUMMARY OF THE INVENTION

It is an aspect of the invention to provide a method of manufacturing a table tennis table with a honeycomb core that conforms to the ITTF guidelines, while being lightweight and easily transportable. These together with other aspects and advantages which will be subsequently apparent, reside in the details of construction and operation as more fully hereinafter described and claimed, reference being had to the accompanying drawings forming a part hereof, wherein like numerals refer to like parts throughout.

### A BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a top view of a table tennis table with a honeycomb core, according to an embodiment;

FIG. 2 is a top view of a table tennis table with a honeycomb core with the top raised to expose the inside, according to an embodiment;

FIG. 3 is a view of a plurality of honeycomb units with unfolded tabs, according to an embodiment;

FIG. 4 is a view of a plurality of honeycomb units with folded tabs inside a border, according to an embodiment;

FIG. 5 is a view of a table tennis table with a tabbed honeycomb core before being pushed through a tab bending guide, according to an embodiment;

FIG. 6 is a view of a table tennis table with a tabbed honeycomb core as it is being pushed through a tab bending guide, according to an embodiment;

FIG. 7 is a perspective view of a table tennis table with a square honeycomb core, according to an alternate embodiment;

FIG. 8 is a perspective view of a table tennis table with a circular honeycomb core, according to an alternate embodiment;

FIG. 9 is a perspective view of a corner of a table tennis table with a honeycomb core, according to an embodiment; and

FIG. 10 is a flowchart illustrating a method of manufacturing a table with a honeycomb core, according to an embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top,” and “bottom,” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected,” and “interconnected,” refer to a relationship wherein structures are secured or attached to one another either directly or indirectly through intervening structures, as well as both movable or rigid attachments or relationships, unless expressly described otherwise.

The present method is designed to produce a honeycombed core table tennis table that can conform to the ITTF guidelines while remaining lightweight and easily transportable. Specifically, the method is designed to create playing surfaces by bonding a planar material, such as medium-density fiberboard (MDF), surfaces to a honeycomb core in such a manner as to create a table tennis table that conforms to the ITTF guidelines, yet is lightweight and easily transportable. In other embodiments, alternate materials can also be substituted for MDF such as wood, metal, plastic, composites, plywood, particle board, carbon fiber, engineered woods or other suitable materials known in the art of table manufacture. In an embodiment, the honeycomb core can be made from aluminum or alternate materials can also be used such as wood, plastic, metal, composites, or cardboard. The manufacturing method can be used to create a table tennis table comprised of one large playing surface, or multiple playing surfaces that can be folded for transport and joined for gameplay.

In an embodiment, the surface area of the honeycomb can be expanded by creating a honeycomb lattice with extra tabs extending from the surface of the honeycomb lattice in the vertical direction. These tabs can be created when the material comprising the honeycomb is first cut into its unexpanded honeycomb lattice configuration. Once the honeycomb is expanded, it can be run through a tab bending guide that uniformly bends all the tabs to a 90 degree angle, creating a larger contact surface area between the honeycomb core and the surface boards.

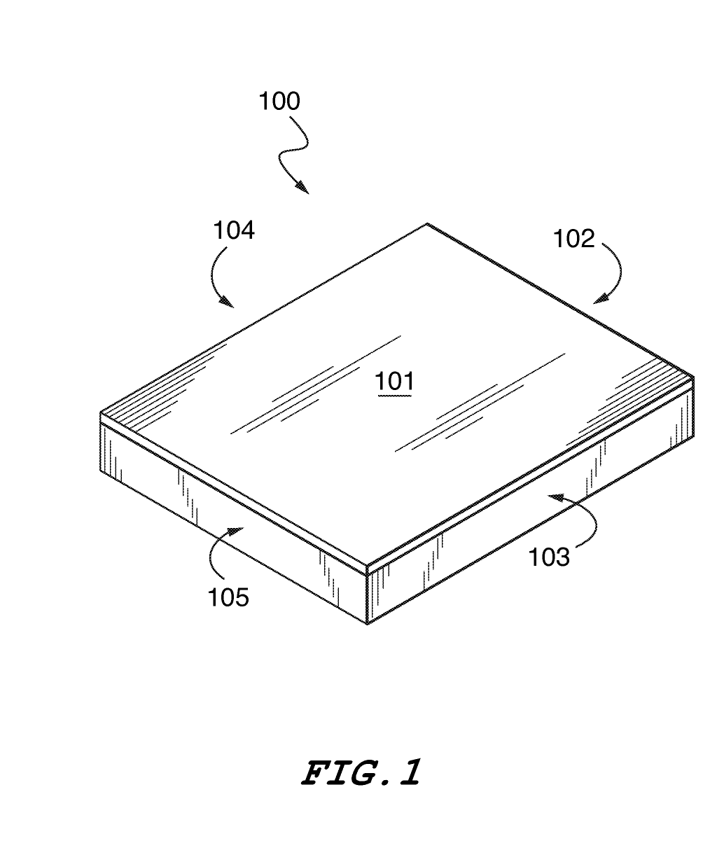

FIG. 1 is a top view of a table tennis table with a honeycomb core, according to an embodiment.

The table tennis table 100 can be created as a single large piece with 2.72 m by 1.52 m dimensions, two half pieces each with 1.36 m by 1.52 m dimensions, four quadrant pieces each with 1.36 m by 0.76 m dimensions, or eight octet pieces each with 0.68 m by 0.76 m dimensions. This figure shows an octet piece of a table tennis table 100. The piece can have an MDF surface 101 and underside (not shown) bonded to an aluminum honeycomb core (not shown). Alternate materials can also be used such as wood, metal, plastic, composites, plywood, particle board, or other engineered woods in place of both MDF and aluminum. Bordering the honeycomb core (not shown) can be a right frame border 102, bottom frame border 103, top frame border 104, and left frame border 105, onto which the upper surface 101 and lower surface (not shown) can be bonded. In the embodiments where the table tennis table 100 is split into two, four, or eight pieces, the pieces can be joined in order to create a table tennis table 100 surface with the proper 2.72 m by 1.52 m dimensions. The upper surface is where the game of table tennis can actually be played upon and can have the standard indicia for play of the table tennis game (not shown). A net (also not shown) can be mounted on top of the upper surface. The border frames 102, 103, 104, 105 can also be made of any material, such as wood, MDF, metal, etc.

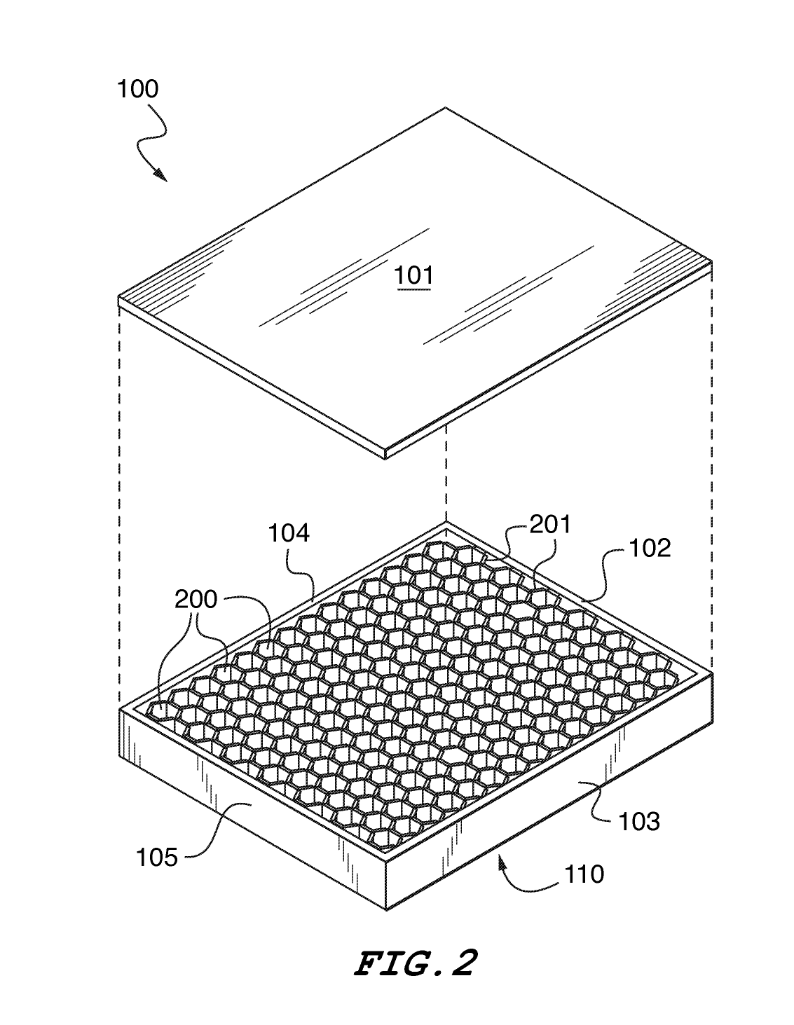

FIG. 2 is a top view of a table tennis table with a honeycomb core with the top raised to expose the inside, according to an embodiment.

The honeycomb core can be comprised of many honeycomb units 200, each having six sides (although in other embodiments any other number of sides can be used, such as pentagons, octagons, etc.) The sides of the honeycomb units 200 can all be attached to their adjacent neighbors' sides via an adhesive. The honeycomb core can be bounded by the upper surface 101 and the lower surface 110. In an embodiment, the honeycomb core can be made from aluminum or alternate materials can also be used such as wood, plastic, metal, composites, or cardboard. In this view, the frame borders 102, 103, 104, 105 surround the honeycomb core. The upper surface 101 and the lower surface 110 (not visible in FIG. 2) can be bonded to the honeycomb core 200 using adhesives that allow minor expansion between the components, but which are elastic enough to allow for solid bounce characteristics off the surfaces that conform to the ITTF guidelines.

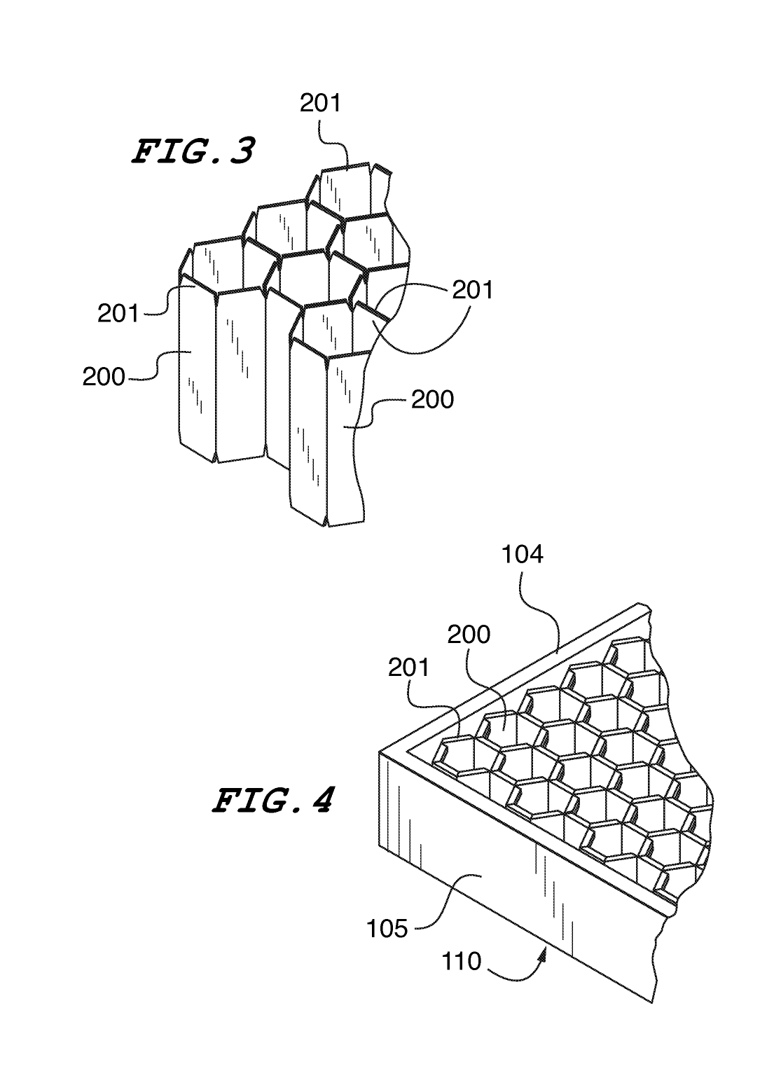

FIG. 3 is a view of a plurality of honeycomb units with unfolded tabs, according to an embodiment;

The individual honeycombs 200 can be manufactured with up to 6 tabs 201 on each end (6 on top and 6 on bottom) that are laid flat during the manufacturing process. The tabs 201 (when folded/bent) increase the contact surface area between the honeycomb 200 and the upper and lower surfaces (not shown). The upper and lower surfaces can be made from any material, such as MDF, wood, metal, etc. Note that optionally the upper and lower surface can also each be constructed in two layers, e.g., an aluminum (or any other material) layer/sheet that contacts the honeycomb core and then another layer (e.g., MDF, wood, etc.) over the aluminum layer. The tabs 201 can be originally manufactured with the honeycomb 200 to extend straight out from the honeycomb 200, then pressed flat by feeding the table tennis table 100 through a tab bending guide (not shown in FIG. 3) beginning with the left frame border 105. Alternatively, any of the other frame borders 102, 103, 104 can be fed through the tab bending guide (not shown) first, but the direction of the tab 201 fold would alter. Note that each tab has a slit cut around it to encourage its easy bending. Each honeycomb unit used would typically be identical or roughly identical to each other (no two honeycomb units could be exactly identical due to machining differences). All sides and tabs on each individual honeycomb unit should also be identical (e.g., same dimensions, materials, thickness, etc.)

Note that the tabs 201 can optionally be treated (before a tab bending guide is used) to be easily bent from each individual respective honeycomb 200 from a predetermined (uniform) distance from a top of each top. This can be done using a number of different methods, for example pre-bending each tab (in one or both directions) at a particular vertical length and then bending it back straight up, or cutting a slight horizontal notch along the length the tab will bend across the tab. Alternatively, no special pre-treatment of the tabs would be necessary as the slit on each side of each tab 201 would allow the tab to easily bend along the slit but not below the slit. Different methods could be used based on the properties of the honeycomb, such as their thickness and materials used. Note each individual honeycomb 200 has 12 tabs, six on top and six on the bottom.

FIG. 4 is a view of a plurality of honeycomb units with folded tabs inside a border, according to an embodiment;

FIG. 4 more clearly shows the tabs 201 and their folded relationship to the honeycomb core 200 and the frame borders 104, 105. A small gap can be left between the honeycomb core 200 and the frame in order to compensate for errors that arise when the tabs 201 are being folded by the tab bending guide (not shown). Note that in contrast to FIG. 3, the tabs 201 have now been folded (bent) which provides more surface area between the honeycomb and the upper surface (not shown in FIG. 4) and lower surface 110 (not visible in FIG. 4). It can be seen that each tab is folded (bent) at a 90 degree (or approximately 90 degree) angle to its original plane (before it was folded).

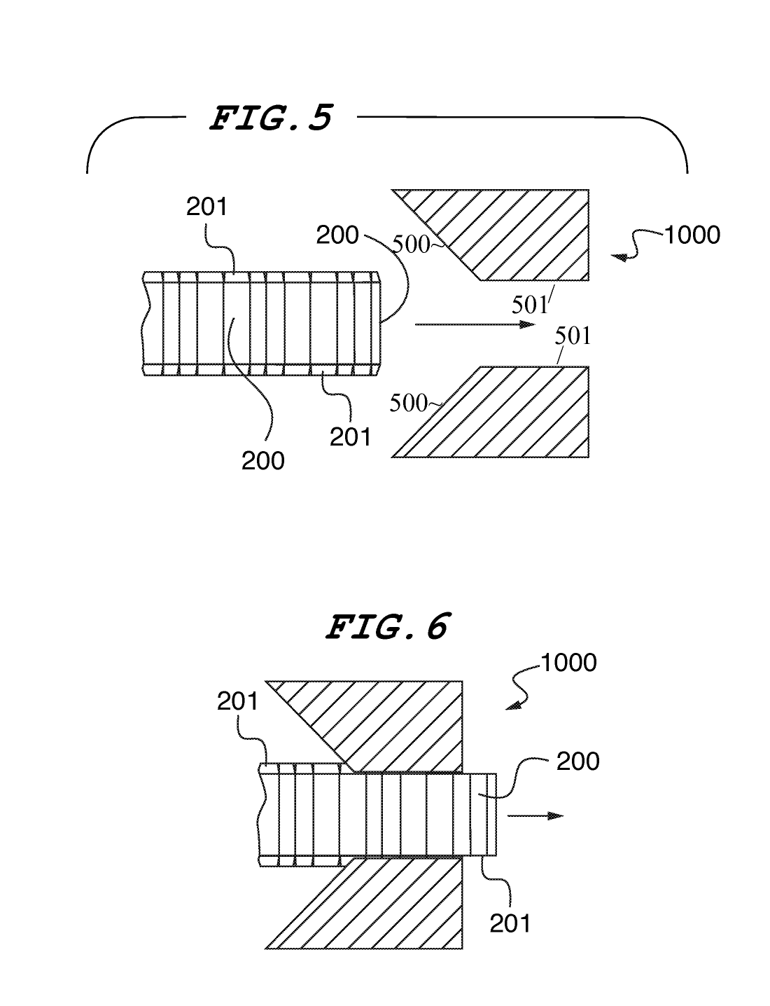

FIG. 5 is a view of a table tennis table with a tabbed honeycomb core 200 before being pushed through a tab bending guide 1000, according to an embodiment.

At this point in the manufacturing process, the honeycomb core's tabs 201 have been created such that they extend straight up past the frame border 104. The table tennis table 100 is positioned at the opening of the tab bending guide 1000, which can comprise a guiding funnel 500 and two plates 501. The guiding funnel 500 and two plates 501 are fixed in location and typically would not shift during this process. The table tennis table 100 is pushed through the guiding funnel 500 and through the plates 501, the tabs 201 being pressed in a direction opposite the pushing motion by the guiding funnel 500 and plates 501, thereby pushing the tabs in a direction opposite from the direction of motion (pushing) and hence folding them generally in that direction. In FIG. 5, the tabs 201 have not yet made contact with the guiding funnel 500.

FIG. 6 is a view of a table tennis table with a tabbed honeycomb core as it is being pushed through a tab bending guide, according to an embodiment. As the table tennis table 100 is passed through the tab bending guide 1000, the tabs 201 are bent to become flush with the plane of the frame border 104 in order to provide more contact between the honeycomb core and the upper and lower surfaces. The guiding funnel 500 and plates 501 put pressure on the tabs as the table is being pressed through the tab bending guide 1000, thereby causing the tabs to bend accordingly. The spacing between the tab bending guide 1000 plates can be only as much as to admit the dimensions of the frame border, in order for the tabs 201 to be folded as close to a 90 degree angle as possible. The entire table is pushed (either manually or using a motorized mechanism such as a conveyor belt) until it comes out the other side and hence all of the tabs have been bent. Of course the upper surface and lower surface are not mounted (glued) yet onto the honeycomb core while the table is being pressed through the tab bending guide 1000. After the table has been entirely pressed (pushed) though the tab bending guide, then the upper and lower surface can be mounted and the table completed. Note that each tab can bend in only two directions, and the direction each tab is bent is generally a product of which side of the table pushed through the tab bending guide first.

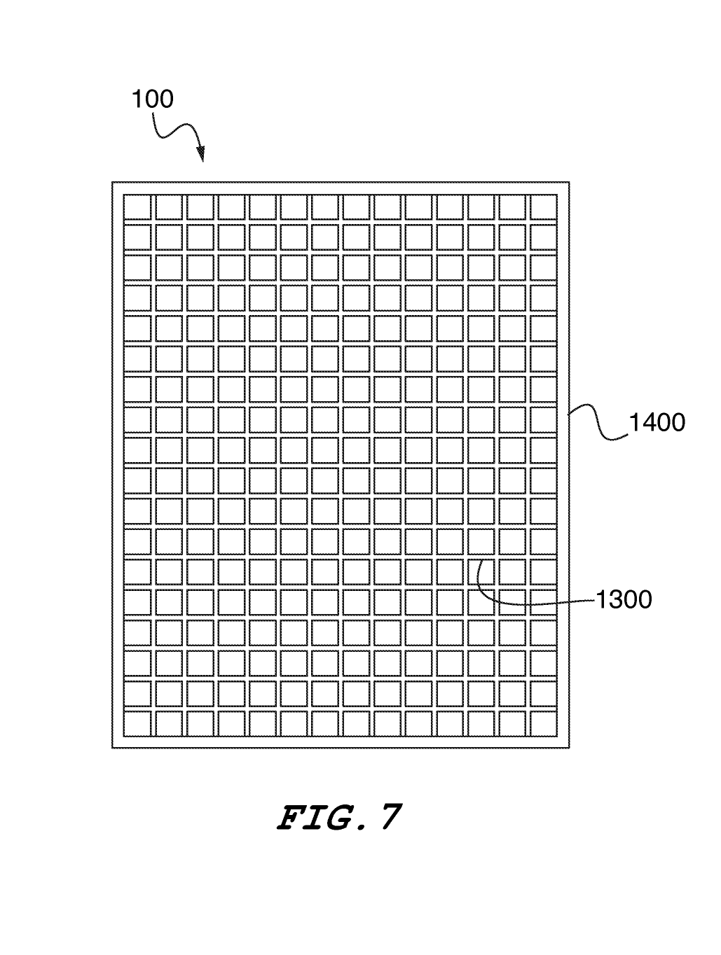

FIG. 7 is a perspective view of a table tennis table with a square honeycomb core, according to an alternate embodiment. Instead of having six sides, as in the previous embodiments, this embodiment of the honeycomb core has four sides per honeycomb, forming a square pattern. Because each honeycomb has four sides, the square honeycomb core 1300 can contact the frame border 1400 with a greater amount of surface area, leading to a stronger bond between the square honeycomb core 1300 and the frame border 1400. Note that this embodiment can also use tabs in the same manner as the hexagonal embodiment described herein.

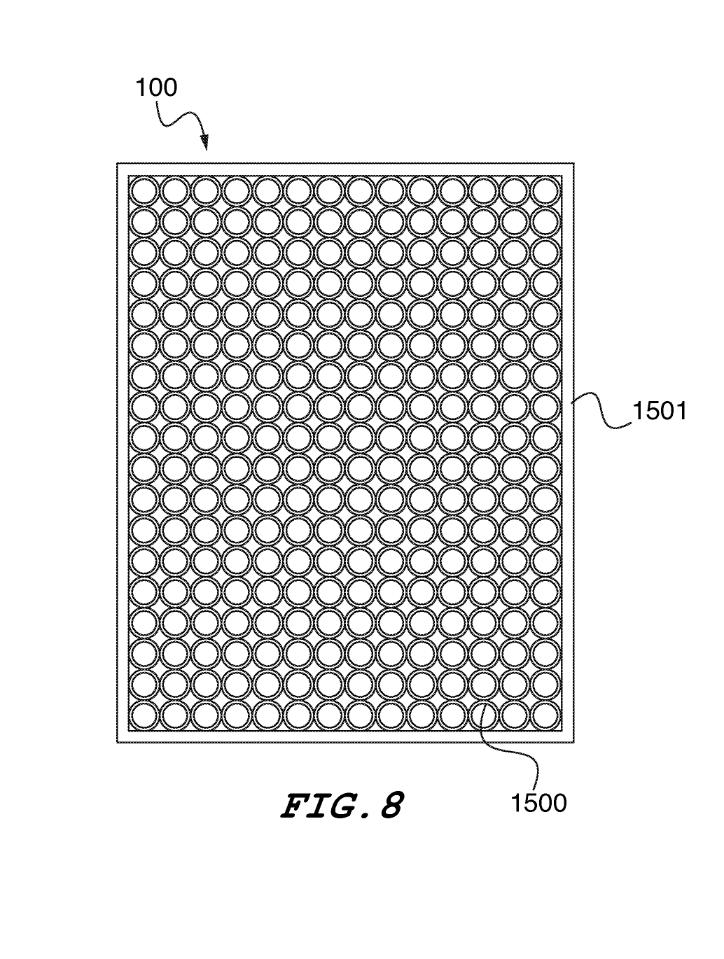

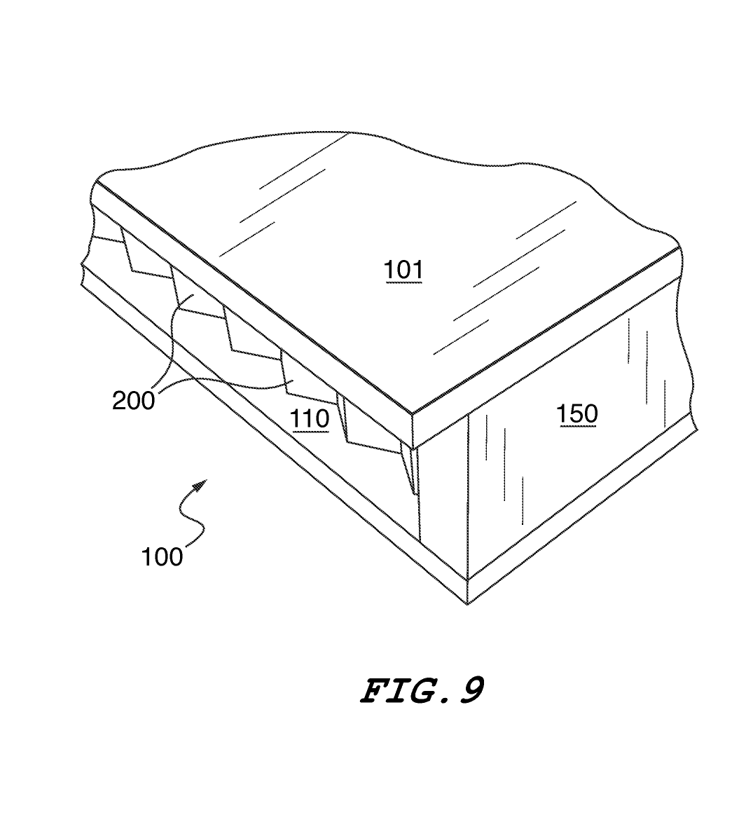

FIG. 8 is a perspective view of a table tennis table with a circular honeycomb core, according to an alternate embodiment. The honeycomb comprising the honeycomb core in this embodiment have no defined sides, and thus are circles, creating a circular honeycomb core 1500, which leads to a reduced surface area for contact with the frame border 1501.

FIG. 9 is a perspective view of a corner of a table tennis table with a honeycomb core, according to an embodiment.

In this view, the outer surface of the honeycomb core 200 can be seen. The honeycomb core can be bonded to the upper surface 101 and the lower surface 110. A frame border 150 can be affixed between the upper surface 101 and lower surface 110 on each edge of the table tennis table 100 to protect the honeycomb core 200.

In an alternate embodiment, the honeycomb core 200 does not have tabs (not shown). This decreases the amount of surface area contact between the honeycomb core 200 and the upper surface 101 and lower surface 110. Frame borders are also not required, as the honeycomb core does not need to pass through a tab bending guide in order to fold the tabs.

Note that to avoid any gaps left between the honeycomb core 200 and the frame border, cut (partial) pieces of honeycomb core 200 can be glued to fill any gap left during manufacture, such that the honeycomb core 200 contacts all frame borders and leaves no unwanted empty space.

Utilizing tabs are optional and any embodiment described herein can be constructed without tabs and the top and bottom of each individual honeycomb are affixed to the respective upper and lower surfaces (there is no folding of tabs).

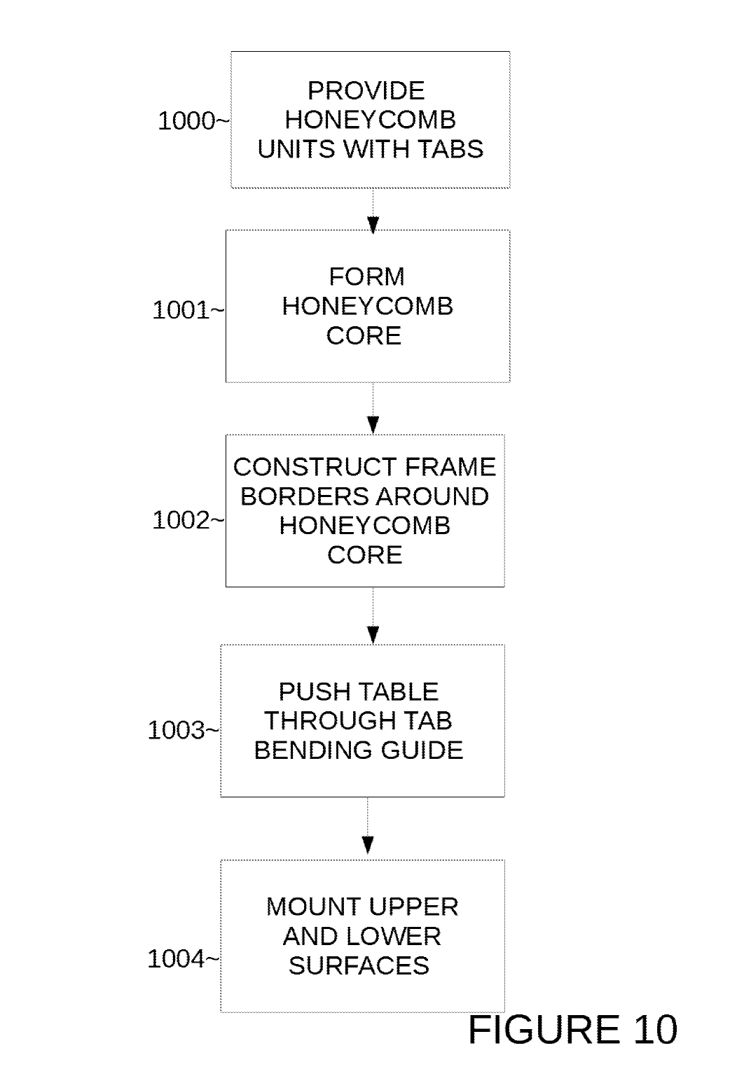

FIG. 10 is a flowchart illustrating a method of manufacturing a table with a honeycomb core, according to an embodiment.

The method begins with operation 1000, which provides honeycomb units with tabs. As described herein the honeycomb units can be any shape, such as a hollow hexagon. The honeycomb unit can be manufactured flat (e.g., cut from a sheet of aluminum) and then folded to create the shape (hexagon or other shape). The thickness of each side of each individual honeycomb unit (e.g., the thickness of the flat sheet it is made from) can be any suitable thickness, such as 0.01 inch thick or any other thickness (e.g., 0.02 inch, 0.05 inch, 0.04 inch, 005 inch, 0.002 inch, from 0.4 mm to 0.5 mm or any other thickness). Each individual honeycomb unit can be any dimensions, such as 0.75 inch high, or from 8 m to 40 mm high (or other height) and the total width of each individual honeycomb unit can be from 20 mm to 40 mm or any other width. These dimensions can all be variable and many different dimensions can be used, as the individual dimensions are not critical. The honeycomb ends of each honeycomb unit can optionally be glued together. For example, a flat sheet of aluminum (or other material) can be folded along six equally spaced creases to form each honeycomb unit (hollow hexagon) in three dimensions. The ends of each honeycomb unit (the ends of the original sheet that meet) can optionally be fastened together (e.g. using an adhesive). The tab slits can be cut (before the honeycomb unit is folded into three dimensions from the sheet or after) using a cutting apparatus (e.g., knife, saw, etc.). Optionally, the tabs can be treated (as described herein) to enable their easy bending along a horizontal line a predetermined distance below the top of each tab before operation 1003 (using the tab bending guide). Ideally, the material and thickness of the tabs would enable their easy bending in operation 1003 without such treatment.

From operation 1000, the method proceeds to operation 1001, which forms a honeycomb core. A large number of honeycomb units (created in operation 1000) can be glued together in order to form a single honeycomb core. At this point the tabs should all typically be straight (unfolded) above and below the each honeycomb unit.

From operation 1001, the method proceeds to operation 1002, which constructs a frame around the honeycomb core. Alternatively, the frame borders can be constructed first and then the honeycomb core formed inside the frame borders.

From operation 1002, the method proceeds to operation 1003, wherein the table (the honeycomb core and the frame borders) is pushed through a tab bending guide. The tab bending guide is described herein and is used to bend (fold) the tabs in an appropriate direction. The entire table is pushed through the tab bending guide thus bending all of the top tabs and bottom tabs on teach honeycomb unit in the table. Note that in another embodiment, the honeycomb units in the honeycomb core only have top tabs (no bottom tabs) or bottom tabs (no top tabs).

From operation 1003, the method proceeds to operation 1004, which mounts the upper and lower surfaces (using an adhesive) onto the top of the honeycomb core and the bottom of the honeycomb core respectively. Because of the bent tabs (which are contacting the upper and lower surfaces) the surface area of the honeycombs which touches the upper and lower surface is increased. Adhesive can be applied to some or all of the upper tabs before the upper surface is mounted on top, and adhesive can be applied to some or all of the lower tabs before the lower surface is mounted on the bottom.

After the table is constructed than items can be added to complete the table as a table tennis table. For example a ball net can be mounted along the middle of the table. In addition, the table can be marked (using paint, stickers, or other marking devices) with standard table tennis indicia (e.g., showing the quadrants of the table).

Adhesives as described herein can comprise glue, rubber cement, or any other known adhesive. In an alternative embodiment, instead of honeycomb units having both top and bottom tabs, each honeycomb unit can have only top tabs or bottom tabs. In addition to what is stated herein, optionally any part described herein can also be constructed from any suitable material (e.g., MDF, metal, aluminum, wood, plastic, etc.)

Although the present apparatus has been described in terms of exemplary embodiments, none is limited thereto. Rather, the appended claims should be construed broadly, to include other variants and embodiments of the present apparatus, which may be made by those skilled in the art without departing from the scope and range of equivalents of either the apparatus or the methods for using such an apparatus.

What is claimed is:

1. A table, comprising:
a core comprising a plurality of connected individual hollow polygonal units;
frame borders surrounding the honeycomb core;
an upper surface mounted on top of the core and frame borders; and
a lower surface mounted on a bottom of the core and frame borders.

2. The table as recited in claim 1, wherein each of the individual polygonal units is a hexagon.

3. The table as recited in claim 1, wherein each of the individual polygonal units is a square.

4. The table as recited in claim 1, wherein each polygonal unit comprises top tabs on a top of the polygonal unit and bottom tabs on a bottom of the polygonal unit.

5. The table as recited in claim 4, wherein each of the top tabs and bottom tabs is bent at approximately a 90 degree angle to a respective side of the polygonal unit.

6. The table as recited in claim 5, wherein each of the top tabs is attached to the upper surface, and each of the bottom tabs is attached to the lower surface.

7. The table as recited in claim 1, wherein the table is a table tennis table.

8. The table as recited in claim 1, wherein the hollow polygonal units are constructed from aluminum.

9. A method to manufacture a table, the method comprising:
providing a plurality of honeycomb units with tabs;
forming a table by connecting the plurality of honeycomb units inside frame borders;
pushing the table through a tab bending guide causing the tabs to bend;
mounting an upper surface on top of the plurality of honeycomb units; and
mounting a lower surface directly beneath the plurality of honeycomb units.

10. The method as recited in claim 9, wherein the tabs on the honeycomb units comprise top tabs and bottom tabs.

11. The method as recited in claim 9, further comprising providing the tab bending guide comprising a guiding funnel and opposing plates.

12. The method as recited in claim 9, wherein the tabs are bent at approximately a 90 degree angle to each tabs' original plane.

13. The method as recited in claim 9, wherein the honeycomb units are hexagonal.

14. The method as recited in claim 9, wherein the honeycomb units are polygonal.

15. The method as recited in claim 9, wherein the honeycomb units are square.
